(19) United States
(12) Patent Application Publication
(10) Pub. No.: US 2017/0344504 A1
(43) Pub. Date: Nov. 30, 2017

(54) METHOD FOR ACCESSING A NUMBER OF SLAVE DEVICES WITH REGISTERS BY A MASTER DEVICE OVER A NETWORK

(71) Applicant: EATON INDUSTRIES (NETHERLANDS) B.V., Hengelo (NL)

(72) Inventors: Bernie Wasserman, Ontario (CA); Siddharth Ramesh Patel, Pune (IN); Atul Jagannath Solvande, Pune (IN)

(21) Appl. No.: 15/538,200

(22) PCT Filed: Dec. 4, 2015
(86) PCT No.: PCT/EP2015/078698

§ 371 Date: Jun. 21, 2017

(30) Foreign Application Priority Data
Dec. 22, 2014 (IN) 3819/DEL/2014
Feb. 11, 2015 (GB) 1502296.5

(51) Int. Cl. G06F 13/38; G06F 13/10; H04W 84/18; G06F 3/06

(52) U.S. Cl. CPC G06F 13/385; H04W 84/18; G06F 13/105; G06F 2003/0697

(57) ABSTRACT

A computer, such as a programmable logic controller (PLC), implemented method for accessing a number of slave devices having a number of registers by a master device on a network includes the steps of: providing a generic driver software in the master device for accessing slave devices on the network; reading by the master device description files, describing the slave devices on the network; and using the description files for converting data read from and written to the generic driver when accessing the slave devices on the network.

### CROSS-REFERENCE TO PRIOR APPLICATIONS

This application is a U.S. National Phase application under 35 U.S.C. §371 of International Application No. PCT/EP2015/078698, filed on Dec. 4, 2015, and claims benefit to Indian Patent Application No. 3819/DEL/2014, filed on Dec. 22, 2014, and British Patent Application No. 1502296.5, filed on Feb. 11, 2015. The International Application was published in English on Jun. 30, 2016 as WO 2016/102176 A1 under PCT Article 21(2).

### FIELD

The invention relates to a computer, such as a programmable logic controller (PLC), implemented method for accessing a number of slave devices having a number of registers by a master device on a network. For example in power distribution systems, a master device is used to control slave devices such as motor control centers to operate these devices and to read out some parameters, such as current and voltages.

### BACKGROUND

Typically, the software in the master device for such systems needs to be programmed to the topology of the network. If a slave device is altered, removed or added, the software needs to be rewritten and recompiled, before the master device can access the altered topology.

To add a slave to the software, an electronic data sheet is added to the software, such that it is known to the software in which memory register of the slave device certain parameters can be read or written. Generally an index and sub-index is defined in the electronic data sheet, which specify the location in the slave memory of specific data.

In complex software systems, the number of slave devices could be high, typically 120, and for each slave device an electronic data sheet is required, such that software for the master becomes large and complex and depends on the quality of the electronic data sheets.

US 2014086241 describes the use of a generic driver to access devices on a network by an application. The generic driver uses configuration files to determine how data read from the devices should be mapped to the application and vice versa. In paragraph 0012 of this publication it is described, that when the physical layout of the devices on the network changes, it is not necessary to use other drivers, but only to change the configuration files to be able to map the data of the devices to the application.

The device according to this prior art thus uses a configuration file on how to access a slave device, similar to the above mentioned electronic data sheets. The disadvantage is that some common and standardized design software used in the field of for example power distribution systems, cannot dynamically load configuration files at the level of the driver to achieve a slave device specific access by the driver. This limitation is also a result of the hardware used.

### SUMMARY

In an embodiment, the present invention provides a computer, such as a programmable logic controller (PLC), implemented method for accessing a number of slave devices having a number of registers by a master device on a network. The method comprises: providing a generic driver as software in the master device for accessing the slave devices on the network; reading by the master device description files, describing the slave devices on the network; and using the description files for converting data read from and written to the generic driver when accessing the slave devices on the network.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic diagram of an embodiment of the computer implemented method according to the invention.

FIG. 2 shows a schematic data diagram for the embodiment of FIG. 1.

### DETAILED DESCRIPTION

This object is achieved with a computer implemented method for accessing a number of slave devices having a number of registers by a master device on a network, which method comprises the steps of:
providing a generic driver software in the master device for accessing slave devices on the network;
reading by the master device description files, describing the slave devices on the network;
using the description files for converting data read from and written to the generic driver when accessing the slave devices on the network.

With the invention any slave device on the network is accessed by the generic driver in the same way. This allows one to have a single description or electronic data sheet on how any slave device on the network is to be accessed. Only after the generic driver has accessed a specific slave device to read some data and this data is sent further by the generic driver, the data is converted based on an description file. The same applies, when data is to be written to a slave device. In such a case, the data is first converted based on the description file and only after the conversion sent to the generic driver, which then accesses the slave device to write the converted data.

Since with the method according to the invention, a single generic driver is used to access all the slaves, the software does not need to be rewritten when changes are made to the topology of the network. Only a description file needs to be changed or added, but as these are read by the master device, the software of the master device does not require to be rewritten and recompiled.

In a preferred embodiment of the computer implemented method according to the invention, the data exchanged between the generic driver and the slave devices has a uniform structure. So, between the generic driver and the slave devices, there is no difference in the structure of the data being written to or read from the slave devices.

In yet another embodiment of the computer implemented method according to the invention, the description files describe the functions of the registers for a slave device.

For example, with a first type of slave device, the first register will contain the voltage value and a second register will contain the current value. A second type of slave device will contain the voltage value in a sixth register and the current value in a seventh register.

The description files will describe on which network address which type of slave device is present and also describe for all the data received from the generic driver, which part correspond to which particular value.

In a further preferred embodiment of the computer implemented method according to the invention the master device comprises a software layer with variables and the description files are used to map the variables to the data read from and written to the generic driver.

Preferably, the network to which the master device and the slave devices are connected, is a controller area network (CAN).

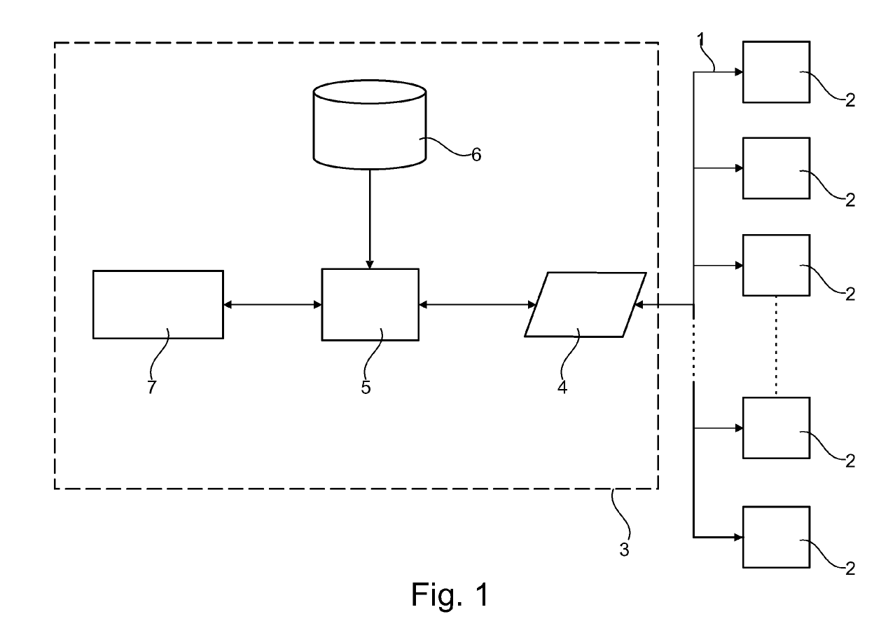

FIG. 1 shows a network 1 to which a number of slave devices 2 are connected as well as a master device 3. The master device 3 has a generic driver 4 which accesses the slave devices 2 on the network 1. The generic driver 4 is connected to a converter 5, which reads data from the generic driver 4 and writes data to the generic driver 4.

The converter 5 uses description files stored in a database 6 to be able to convert data read from the generic driver 4 and send it further to a next process 7 or to convert data received from the next process 7 and after conversion send it to the generic driver 4, such that it can be written in a generic way to one of the slave devices 2.

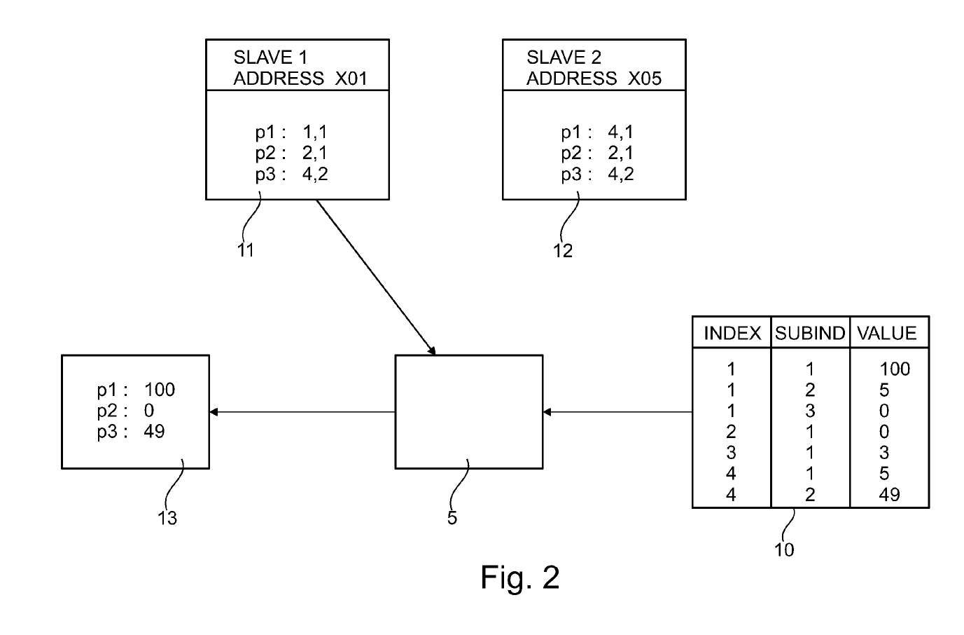

FIG. 2 shows a schematic data diagram for the embodiment of FIG. 1. Data 10 read from a slave 2 on the network by the generic driver 4 contains rows of data divided into a main index, a sub-index and the value present in the register, identified by main index and sub-index, of the specific slave 2. This data 10 would be meaningless in its current form for the next process 7 meaningless and has to be converted first by the converter 5.

Based on the address from where the data 10 is read, one of the description files 11, 12 is selected and used to convert the data 10. Each description file describes which parameter is present on which location within the data 10. This results in converted data 13, which can be further used by the next process 7. For example, the description file 11 defines that the value for parameter p2 can be found on index 2, sub-index 1. In the present example this results in a value of 0 for parameter p2 using the data 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A computer, such as a programmable logic controller (PLC), implemented method for accessing a number of slave devices having a number of registers by a master device on a network, the method comprising:
providing a generic driver as software in the master device for accessing the slave devices on the network;
reading by the master device description files, describing the slave devices on the network; and
using the description files for converting data read from and written to the generic driver when accessing the slave devices on the network.

2: The computer implemented method according to claim 1, wherein the data exchanged between the generic driver and the slave devices has a uniform structure.

3: The computer implemented method according to claim 1, wherein the description files describe the functions of the registers for a slave device.

4: The computer implemented method according to claim 1, wherein the master device comprises a software layer with variables and wherein the description files are used to map the variables to the data read from and written to the generic driver.

5: The computer implemented method according to claim 1, wherein the network to which the master device and the slave devices are connected comprises a controller area network (CAN).
